(19) United States
(12) Patent Application Publication
(10) Pub. No.: US 2026/0359416 A1
(43) Pub. Date: Nov. 12, 2026

(54) Methods, Systems, and Electronic Devices for Seamless Device Collaboration and Unlocking via Wearable Image Capture Devices

(71) Applicant: Motorola Mobility LLC, Chicago, IL (US)

(72) Inventors: Ioannis A Zigras, Chicago, IL (US); Ranjeet Gupta, Aurora, IL (US)

(21) Appl. No.: 19/232,523

(22) Filed: Jun. 9, 2025

(30) Foreign Application Priority Data
May 8, 2025 (GR) 20250100341

(51) Int. Cl. G06F 21/35; G06F 21/32; G06T 7/536; G06V 10/764; G06V 40/16

(52) U.S. Cl. CPC G06F 21/35; G06F 21/32; G06T 7/536; G06V 10/764; G06V 40/172; G06V 2201/02

(57) ABSTRACT

A method in an electronic device includes processing, by one or more processors, image sensor data received from an image capture device of the electronic device to detect a companion electronic device configured to perform optical biometric authentication of a user within an environment of the electronic device. Responsive to detecting the companion electronic device within the environment of the electronic device, the method includes automatically transmitting, by a communication device, an unlock command to the companion electronic device causing the companion electronic device to initiate the biometric authentication of the user. This facilitates seamless device collaboration, enhancing both user convenience and security by eliminating the need for manual interactions. As a result, the method not only streamlines workflows but also optimizes device interaction efficiency in dynamic environments.

### CROSS REFERENCE TO PRIOR APPLICATIONS

This application claims priority and benefit under 35 U.S.C. §119 from Greek Patent Application No. 20250100341, filed May 8, 2025, which is incorporated by reference by rule in accordance with 37 CFR §1.57.

### BACKGROUND

### TECHNICAL FIELD

This disclosure relates generally to electronic devices, and more particularly to electronic devices having image capture devices and wireless communication capabilities.

### BACKGROUND ART

The technology associated with personal electronic devices, including smartphones, tablet computers, and wearable gadgets, has advanced remarkably over recent years. By way of illustration, while earlier applications featured limited display capabilities and manual interfaces, today’s systems incorporate sophisticated sensors and compact designs that offer a much richer interaction.

While modern devices integrate high-definition displays and advanced sensor arrays to facilitate a broad range of functionalities, many still rely heavily on explicit user commands to initiate important operations. This reliance on manual input for tasks such as unlocking or activating necessary functions can interrupt user workflows and detract from an otherwise seamless experience. It would be advantageous to have improved systems, methods, and devices that more seamlessly perform routine functions.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates an explanatory system in accordance with one or more embodiments of the disclosure.

FIG. 3 illustrates one explanatory method in accordance with one or more embodiments of the disclosure.

FIG. 4 illustrates one or more method steps in accordance with one or more embodiments of the disclosure.

FIG. 5 illustrates one or more method steps in accordance with one or more embodiments of the disclosure.

FIG. 6 illustrates one or more method steps in accordance with one or more embodiments of the disclosure.

FIG. 7 illustrates another explanatory method in accordance with one or more embodiments of the disclosure.

FIG. 8 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to processing, by one or more processors, image sensor data received from an image capture device of the electronic device to detect a companion electronic device configured to perform optical biometric authentication of a user within an environment of the electronic device and, responsive to detecting the companion electronic device within the environment of the electronic device, automatically transmitting, by a communication device, an unlock command to the companion electronic device causing the companion electronic device to initiate the biometric authentication of the user. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to analyze the image sensor data to detect a companion electronic device configured to perform facial recognition to unlock the companion electronic device depicted in the image sensor data and automatically cause the communication device to transmit an unlock command to the companion electronic device depicted in the image sensor data as described herein. The non-processor circuits may include, but are not limited to, a radio receiver, a radio transmitter, signal drivers, clock circuits, power source circuits, and user input devices.

As such, these functions may be interpreted as steps of a method to perform monitoring, by one or more processors, image sensor data received from a camera of the electronic device, processing, by the one or more processors, the image sensor data with an artificial intelligence (AI) image classification algorithm to detect, based on predetermined image features and/or device appearance characteristics depicted in the image sensor data, a companion electronic device having a hardware camera and in a locked state, determining, using one or more sensors, a proximity between the camera and the companion electronic device and automatically transmitting, by a communication device via a wireless communication channel, an unlock command to the companion electronic device in response to detecting that the companion electronic device is locked and is within a predefined distance of the camera.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

In today's fast-paced digital environment, electronic devices such as smartphones, tablets, and laptops have become a significant part of daily life, providing users with a wide array of functionalities. Despite advancements in technology, these devices often require explicit user interaction to perform important tasks, such as unlocking or activating security features. This reliance on manual input can disrupt user workflows, particularly in dynamic environments where seamless interaction is desired. Embodiments of the disclosure contemplate that the need for improved systems and methods that facilitate more intuitive and streamlined access to electronic devices without necessitating overt user intervention is increasingly apparent.

Current solutions for unlocking electronic devices typically involve manual input, such as entering a password or using biometric data like fingerprint or facial recognition. These methods, while effective, require the user to initiate the unlocking process, which can be cumbersome and time-consuming. For instance, a user needs to physically interact with a device to trigger sensors or activate hardware buttons to start the face recognition process. This requirement for physical input can be particularly inconvenient in situations where the user is engaged in other activities or when the device is not easily accessible.

Advantageously, embodiments of the present disclosure address these challenges by introducing a method and system for seamless device collaboration and unlocking via wearable image capture devices. The described method leverages advanced image processing and wireless communication technologies to automatically detect and unlock companion electronic devices without requiring explicit user interaction. By utilizing a wearable camera device, the system can identify nearby devices equipped with optical biometric authentication capabilities and initiate the unlocking process based on proximity and device recognition. This approach not only enhances the user experience by reducing the need for manual input but also improves the security and efficiency of device interactions in various environments

In one or more embodiments, a method executed in an electronic device involves processing image sensor data received from an image capture device to detect a companion electronic device configured for optical biometric authentication of a user within the device's environment. Upon detecting the presence of the companion electronic device, in one or more embodiments the method automatically transmits an unlock command via a communication device to the companion electronic device, prompting the companion electronic device to initiate the biometric authentication process.

In one or more embodiments, this method utilizes advanced image processing techniques to identify the companion device, thereby facilitating a seamless and efficient unlocking process without requiring explicit user interaction. The integration of wireless communication capabilities ensures that the unlock command is transmitted promptly, enhancing the overall user experience by reducing the need for manual input and improving the security and efficiency of device interactions.

Advantageously, this method enhances user convenience by eliminating the need for manual interaction to unlock devices, thereby streamlining the user experience. The integration of image processing and wireless communication allows for seamless device collaboration, reducing interruptions in user workflows.

By leveraging image sensor data, the method ensures that the unlocking process is initiated only when the companion device is detected within the environment, enhancing security by preventing unauthorized access. This approach also optimizes the efficiency of device interactions, as the method allows for quick and automatic unlocking based on proximity and device recognition, which is particularly beneficial in dynamic environments where manual input can be cumbersome.

In one or more embodiments, an electronic device is configured as a wearable electronic device, which enhances the convenience and accessibility of the unlocking process. The wearable electronic device is equipped with an image capture device that continuously monitors the environment for the presence of a companion electronic device. Upon detecting the companion device, the wearable device processes the image sensor data to determine if the companion device is configured for optical biometric authentication and is in a locked state.

In one or more embodiments, the wearable device then automatically transmits an unlock command to the companion device, facilitating a seamless and efficient unlocking process without requiring explicit user interaction. This approach not only streamlines the user experience by reducing the need for manual input but also enhances security by ensuring that the unlocking process is initiated only when the companion device is detected within the environment. The integration of wireless communication capabilities in the wearable device ensures prompt transmission of the unlock command, thereby improving the overall efficiency and security of device interactions.

Advantageously, by being wearable, the device can maintain ongoing awareness of its surroundings, enabling detection of the companion device without requiring the user to manually initiate the process. This setup enhances user convenience by allowing the unlocking process to occur seamlessly and automatically as the user moves within proximity of the companion device.

The wearable nature of the device ensures that the device is consistently in an optimal position to capture relevant image sensor data, thereby improving the accuracy and reliability of detecting the companion device. This arrangement reduces the need for user intervention, streamlining the user experience and allowing for more efficient device interactions in dynamic environments.

In one or more embodiments, an electronic device comprises an image capture device configured to capture image sensor data from the surrounding environment, a communication device, and one or more processors operatively coupled to both the image capture device and the communication device. In one or more embodiments, the processors are programmed to analyze the image sensor data to detect a companion electronic device that is configured to perform facial recognition for unlocking purposes.

Upon detection of the companion electronic device within the captured image sensor data, the processors automatically cause the communication device to transmit an unlock command to the companion electronic device. This process facilitates the unlocking of the companion electronic device without requiring explicit user interaction, thereby enhancing user convenience and streamlining device operations. The integration of image processing and wireless communication capabilities ensures that the unlock command is transmitted efficiently, improving the overall user experience by reducing the need for manual input and enhancing the security and efficiency of device interactions.

The arrangement of the image capture device and processors enables the electronic device to continuously monitor the environment for the presence of a companion device. By leveraging image processing capabilities, the system can accurately identify the companion device based on the appearance in the captured image data. This reduces the need for manual input, thereby streamlining the user experience and enhancing convenience.

The integration of the communication device ensures that the unlock command is transmitted promptly once the companion device is detected, improving the efficiency of device interactions. This setup not only enhances user convenience by automating the unlocking process but also improves security by ensuring that the process is initiated only when the companion device is within the environment. The use of image processing and wireless communication technologies in this manner represents a novel approach to device interaction, offering an alternative to traditional manual unlocking methods.

The companion electronic device is identified as having a hardware camera and being in a locked state. The method further includes determining a proximity between the camera and the companion electronic device using one or more sensors. Upon detecting that the companion electronic device is locked and within a predefined distance of the camera, the method automatically transmits an unlock command via a communication device through a wireless communication channel to the companion electronic device. This process facilitates the unlocking of the companion electronic device without requiring explicit user interaction, thereby enhancing user convenience and streamlining device operations.

Other advantages will be described below. Still others will be obvious to those of ordinary skill in the art having the benefit of this disclosure.

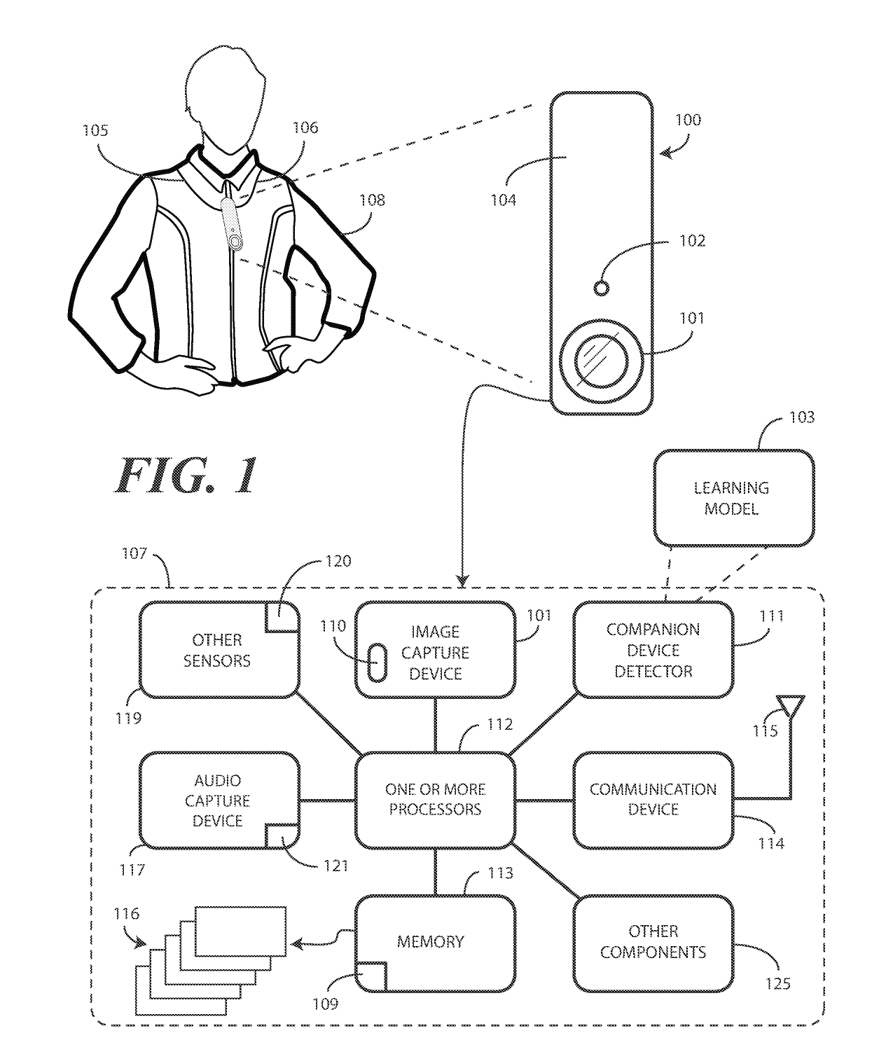

Turning now to FIG. 1, illustrated therein is one explanatory electronic device 100 configured in accordance with one or more embodiments of the disclosure. In one or more embodiments, the electronic device 100 includes a wearable sensor arrangement comprising one or more sensors 119 that designed to detect a companion electronic device configured to perform optical biometric authentication of a user within an environment of the electronic device and, responsive to detecting the companion electronic device within the environment of the electronic device, comprising a communication device 114 that automatically transmits an unlock command to the companion electronic device causing the companion electronic device to initiate the biometric authentication of the user 108.

In one or more embodiments, the one or more sensors 119 comprise an image capture device 101 and a microphone 102 that serves as an audio capture device 117. In one or more embodiments, the microphone 102 and image capture device 101 are each in electronic communication with one or more processors 112. In one or more embodiments, the image capture device 101 of the electronic device 100 acquires image sensor data, and one or more processors utilize a companion device detector 111 that is trained with an artificial intelligence (AI) based learning model to analyze the image sensor data to identify characteristics associated with restricted areas.

In one or more embodiments upon detection of such restricted area characteristics, the one or more processors 112 perform one or more operations such as disabling the image capture device 101 or deleting data from a memory 113 of the electronic device 100. In one or more embodiments, in response to environmental stimuli indicating a hospital or government facility setting, the one or more processors 112 transition to a privacy-enhanced mode of operation where selected functions are precluded to ensure compliance with legal norms.

As a result, the electronic device 100 advantageously enhances privacy by dynamically adapting to the surrounding environment. By automatically disabling the image capture device 101 in sensitive areas, the electronic device 100 provides a seamless user experience without manual intervention.

In this explanatory embodiment, the electronic device 100 is configured as a wearable electronic device. This illustrative wearable electronic device has a housing 104. In some embodiments, the electronic device 100 can also include and one or more straps 105,106 that allow the wearable electronic device to be worn around a user’s neck. In other embodiments, the electronic device 100 can be worn as a brooch by being clipped to a garment.

While a necklace or brooch is one embodiment of a wearable electronic device configured in accordance with one or more embodiments of the disclosure, other types of wearable electronic devices and/or other mechanical configurations of wearable electronic devices will be obvious to those of ordinary skill in the art having the benefit of this disclosure. Illustrating by example, in other embodiments the electronic device 100 could be configured as a headband or smartwatch.

Also illustrated in FIG. 1 is one explanatory block diagram schematic 107 of the wearable electronic device. It should be noted that the block diagram schematic of FIG. 1 includes many components that are optional, but which are included in an effort to demonstrate how varied electronic devices configured in accordance with embodiments of the disclosure can be. Accordingly, it is to be understood that the block diagram schematic of FIG. 1 is provided for illustrative purposes only and for illustrating components of one wearable electronic device in accordance with embodiments of the disclosure. The block diagram schematic of FIG. 1 is not intended to be a complete schematic diagram of the various components required for a wearable electronic device.

Therefore, other wearable electronic devices in accordance with embodiments of the disclosure may include various other components not shown in FIG. 1 or may include a combination of two or more components or a division of a particular component into two or more separate components and §still be within the scope of the present disclosure. A wearable electronic device may have fewer, or different, components from another wearable electronic device configured in accordance with embodiments of the disclosure. Accordingly, wearable electronic devices configured in accordance with embodiments of the disclosure can include some components that are not shown in FIG. 1, and other components that are shown may not be needed and can therefore be omitted.

This illustrative wearable electronic device can include an optional display, which in one embodiment is touch-sensitive and defines a user interface for the wearable electronic device. In the illustrative embodiment of FIG. 1, the electronic device 100 is a dedicated “data capture” device that is devoid of a display. Where a display is included, users may be able deliver user input to the display of such an embodiment by delivering touch input from a finger, stylus, or other objects disposed proximately with the display.

Features can be incorporated into the housing 104. Illustrating by example, a biometric sensor might be disposed along a surface of the housing 104 so that a user 108 of the electronic device 100 can be authenticated. Where included, the biometric sensor can be responsible for identifying biometric input received at the biometric sensor to authenticate or otherwise identify the user 108 as an authorized user of the wearable electronic device. Other devices can be disposed along the housing 104 as well. Examples of such devices include a speaker port for an audio output device.

The image capture device 101 can include one or more components. For example, in one or more embodiments the image capture device 101 comprises and one or more of an image sensor, a depth imager, and, optionally, one or more proximity sensors.

In one embodiment, the image capture device 101 comprises a two-dimensional imager configured to receive at least one image of an environment about the wearable electronic device. In one embodiment, the image capture device 101 comprises a two-dimensional Red-Green-Blue (RGB) imager. In another embodiment, the image capture device 101 comprises an infrared imager. Other types of imagers suitable for use as the image capture device 101 of wearable electronic device will be obvious to those of ordinary skill in the art having the benefit of this disclosure.

The one or more proximity sensors, where included, can take various forms. In one or more embodiments, the one or more proximity sensors fall into one of two camps: active proximity sensors and “passive” proximity sensors. Either the proximity detector components or the proximity sensor components can be generally used for detecting persons and/or present within the environment, distances between warm objects and the wearable electronic device, changes in distance between warm objects and the wearable electronic device, and other information. Accordingly, in one or more embodiments the one or more proximity sensors can be used as a “wearability” detector by detecting the wearable electronic device being proximately located and worn by an authorized user.

As used herein, a “proximity sensor component” comprises a signal receiver only that does not include a corresponding transmitter to emit signals for reflection off an object to the signal receiver. A signal receiver only can be used due to the fact that a user’s body or other heat generating object external to the wearable electronic device serves as the transmitter. In one embodiment, the signal receiver is an infrared signal receiver to receive an infrared emission from a source, such as a human being, when the human being is approaching the wearable electronic device.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

In one embodiment, the one or more proximity sensors simply comprise a proximity sensor component. In another embodiment, the one or more proximity sensors comprise a simple thermopile. In another embodiment, the one or more proximity sensors comprise an infrared imager that captures the amount of thermal energy emitted by an object. In still other embodiments, the one or more proximity sensors comprise a proximity detector component. Of course, combinations of these components can be used as the one or more proximity sensors. Moreover, other types of proximity sensors suitable for use with the wearable electronic device will be obvious to those of ordinary skill in the art having the benefit of this disclosure.

As with the one or more proximity sensors, the depth imager, where included, can take a variety of forms. In a first embodiment, the depth imager comprises a pair of imagers separated by a predetermined distance, such as three to four images. This “stereo” imager works in the same way the human eyes do in that it captures images from two different angles and reconciles the two to determine distance.

In another embodiment, the depth imager employs a structured light laser. The structured light laser projects tiny light patterns that expand with distance. These patterns land on a surface, such as a user’s face, and are then captured by an imager. By determining the location and spacing between the elements of the pattern, three-dimensional mapping can be obtained.

In still another embodiment, the depth imager comprises a time-of-flight device. Time of flight three-dimensional sensors emit laser or infrared pulses from a photodiode array. These pulses reflect back from a surface, such as the user’s face. The time it takes for pulses to move from the photodiode array to the surface and back determines distance, from which a three-dimensional mapping of a surface can be obtained. Regardless of embodiment, the depth imager adds a third “z-dimension” to the x-dimension and y-dimension defining the two-dimensional image captured by the image capture device 101, thereby enhancing the accuracy of detecting persons being present within the environment.

In one or more embodiments, the image capture device 101 includes a plurality of photosensitive elements that receive light from the environment of the electronic device 100 and generate electronic signals indicating characteristics of the received light, such as intensity, wavelength, and so forth. In one or more embodiments, the electronic signals from the photosensitive elements are used by the electronic device 100 to assign values (e.g., color or grayscale values) to pixels in pixel data associated with the digital images.

In one or more embodiments, the image capture device 101 can acquire image data in various modes. Such modes may include, for example, a continuous imaging mode and a shuttered mode.

In the continuous imaging mode, the image capture device 101 continuously acquires preview image data in real-time and without interruption. For example, while in the continuous imaging mode, the image capture device 101 generates preview image frames continuously at a pre-determined rate or a rate specified by a user of the electronic device 100 via user input. These preview image frames can be stored in the rolling buffer of the memory 113.

The rate of preview image frame generation may be, for example, fifteen preview image frames per second, thirty preview image frames per second, sixty preview image frames per second, etc. Therefore, while operating in the continuous imaging mode, the preview image data generated by the image capture device 101 can include a plurality of preview image frames generated over a span of time (e.g., a duration of operating in the continuous imaging mode). In some instances, the preview image data may be formatted as video data.

In the shuttered mode, the image capture device 101 is operable to acquire individual preview image frames or a series of preview image frames including a pre-defined number of preview image frames responsive to input received by the electronic device 100. The input may include, for example, user input applied via one or more physical buttons of the electronic device 100, touchscreen input, and so forth.

In some implementations, the image capture device 101 may default to operating in the continuous imaging mode following power-on of the electronic device 100. Power-on of the electronic device 100 includes, for example, adjustment of the electronic device 100 from an “off” condition in which the electronic device 100 is inactive and not processing data, to an “on” condition in which the electronic device 100 is active and employing resources supporting operation of the operating system, applications, and so forth.

As one example, the electronic device 100 may be configured to be worn by a user (e.g., as a necklace or brooch or other type of worn device) and may operate with the image capture device 101 in the continuous imaging mode until receiving user input to deactivate the continuous imaging mode (e.g., user input to turn off the image capture device 101 or adjust the image capture device 101 to a different operating mode such as the shuttered mode). The user input may include, for instance, touch applied to one or more physical buttons of the electronic device 100, selection of one or more graphical user interface elements displayed by the display, and so forth.

In one or more embodiments, the image capture device 101 can be operable with a companion device detector 111. In one or more embodiments, the companion device detector 111 can be configured to process an image or depth scan of an object and determine whether the object matches predetermined criteria by comparing the image or depth scan to one or more predefined authentication references stored in memory 113. In one or more embodiments, the predetermined criteria comprise determining a companion electronic device configured to perform optical biometric authentication of a user 108 is within an environment of the electronic device 100.

For example, the companion device detector 111 can identify whether one or more persons or objects are within an environment of the wearable electronic device in one or more embodiments. Additionally, by comparing the images and/or depth scans to the predefined authentication references, in one or more embodiments the companion device detector 111 can identify the objects within the environment. In one or more embodiments the companion device detector 111 can employ optical and/or spatial recognition to identify persons or objects using image recognition, character recognition, visible recognition, facial recognition, color recognition, shape recognition, and the like.

In one or more embodiments, the companion device detector 111 is configured to analyze the image sensor data using an artificial intelligence model 103 trained to classify objects as companion electronic devices, and more particularly, companion electronic devices capable of authenticating the user 108 as an authorized user of the companion electronic device using optical biometrics. In one or more embodiments, the companion device detector 111 is a component of an electronic device that utilizes an artificial intelligence (AI) model 103 to identify paired companion electronic devices that use facial recognition to unlock the companion electronic device.

In one or more embodiments, when the image capture device 101 captures image sensor data, this image sensor data is delivered to the companion device detector 111. In one or more embodiments, this image sensor data is then analyzed by the AI model 103. In one or more embodiments, the AI model 103 has been trained to recognize specific features or signs that indicate a companion electronic device having optical biometric authentication. For example, the AI model 103 might look a camera on the companion electronic device along with the absence of other authentication devices, such as fingerprint sensors.

In one or more embodiments, the AI model 103 is trained only identifying such companion electronic devices. Advantageously, this makes the AI model 103 very quick and light so that quick responses can be obtained when items such as laptops with facial recognition, tablets with facial recognition, or other devices are detected.

In some embodiments, the companion device detector 111 can also analyze sounds when electrical signals corresponding to those sounds are received from the microphone 102. Embodiments of the disclosure contemplate that in one or more embodiments sound can be utilized to determine whether a companion electronic device configured to perform optical biometric authentication of a user is within the environment of the electronic device. In one or more embodiments, this determination is achieved by analyzing audio sensor data captured by a microphone integrated into the electronic device.

In one or more embodiments, the audio data is processed using an artificial intelligence model 103 trained to recognize specific acoustic signatures or patterns associated with the presence of the companion device. For instance, the model may identify sounds emitted by the companion device, such as system notifications or operational noises, which indicate proximity. Additionally, the electronic device 100 can detect ambient sounds that correlate with environments where the companion device is typically used, such as the hum of a laptop fan or the click of a keyboard.

By cross-referencing these auditory cues with visual data from the image capture device, the system enhances accuracy in identifying the presence of the companion device, thereby facilitating seamless and automatic unlocking processes. This multimodal approach ensures that the electronic device can reliably ascertain the presence of the companion device, even in scenarios where visual confirmation alone may be insufficient.

In one or more embodiments, the AI model 103 can utilize both image and audio data in conjunction to make a more precise determination. This approach allows the model to cross-reference visual information with auditory input to assess whether a companion electronic device configured to perform optical biometric authentication of a user is within an environment of the electronic device.

In one or more embodiments, the AI model 103 uses an artificial intelligence image classification algorithm to identify the companion electronic device and is stored and operates directly on the electronic device 100. This approach eliminates the need to send data to the cloud for processing, which helps protect user privacy and accelerates the detection process. In some embodiments, the image sensor data received from the image capture device 101 is stored temporarily in a rolling buffer located in the memory 113.

In one or more embodiments, when a companion electronic device configured to perform optical biometric authentication of a user is detected as being within an environment of the electronic device 100, a communication device 114 of the electronic device 100 can automatically transmit an unlock command 109 to the companion electronic device causing the companion electronic device to initiate the biometric authentication of the user 108.

Said differently, in one or more embodiments one or more processors 112 of the electronic device 100 analyze the image sensor data 110 to detect a companion electronic device configured to perform facial recognition to unlock the companion electronic device depicted in the image sensor data 110. In one or more embodiments, the one or more processors 112 automatically cause the communication device 114 to transmit an unlock command to the companion electronic device depicted in the image sensor data 110.

In some embodiments, determining that the distance between the electronic device 100 and the companion electronic device is below a predefined distance threshold is important for enhancing security and ensuring seamless device interaction. By establishing a proximity requirement, the electronic device 100 can prevent unauthorized access and accidental unlocking of devices that are not intended to be unlocked.

For instance, a predefined distance of two feet or less can be set for personal devices like smartphones or laptops, ensuring that only devices within the immediate vicinity of the user are unlocked. This proximity-based approach is particularly beneficial in crowded environments, such as offices or public spaces, where multiple devices may be present, and distinguishing between them based solely on identification could lead to security breaches.

Additionally, in scenarios where the user is moving, such as walking through an airport or a busy street, maintaining a close proximity threshold ensures that the device remains secure and responsive only to the intended companion device. Other predefined distances, such as five feet for home settings or ten feet for larger office spaces, can be employed to tailor the system's responsiveness to different environments, thereby optimizing both security and user convenience

Accordingly, one or more embodiments the electronic device 100 comprises one or more sensors 119, one of which is a distance determination sensor implemented with a location detector 120. In one or more embodiments, the one or more processors 112 cause the one or more sensors 119 to determine a distance between the electronic device 100 and the companion electronic device. Thereafter, in one or more embodiments the one or more processors 112 cause the communication device 114 to transmit the unlock command 109 when the distance is within a predefined proximity and the companion electronic device is in a locked state.

In one or more embodiments, the electronic device 100 utilizes distance measurements to manage the unlocking and locking of companion devices. Specifically, the one or more sensors 119 can be configured to determine the proximity between the electronic device 100 and the companion electronic device. When the sensors detect that the companion device is within a predefined proximity, an unlock command 109 can be automatically transmitted to initiate the biometric authentication process.

Conversely, if the one or more sensors 119 subsequently determine that the distance between the electronic device 100 and the companion device exceeds the predefined proximity, a lock command is automatically transmitted to the companion device, causing the companion device to enter a locked state. This distance-based approach ensures that the unlocking and locking processes are responsive to the physical location of the devices, thereby enhancing security by preventing unauthorized access when the devices are not in close proximity.

In some embodiments, when the unlock command 109 or lock command is transmitted, the companion device detector 111 can alert the user 108. This might be through a vibration, a sound, or a notification on a connected device, like a smartphone.

The electronic device 100 of FIG. 1 and its companion device detector 111 can be particularly useful in various scenarios where seamless device interaction is desired. For instance, in a professional setting, such as an office or conference room, the electronic device 100 allows users to unlock their laptops or tablets without interrupting ongoing meetings or presentations, thereby enhancing productivity and maintaining focus.

In a home environment, the method can be employed to unlock personal devices like smartphones or smart TVs, facilitating quick access to entertainment or communication applications without the need for manual input, which is especially beneficial when multitasking or engaging in household activities. Additionally, in public spaces such as airports or cafes, the electronic device 100 provides a secure and efficient way to access devices, reducing the risk of unauthorized access while ensuring convenience for users who are on the move. These use cases demonstrate the versatility and practicality of the method in improving user experience across different environments.

The electronic device 100 includes one or more processors 112. The one or more processors 112 can be operable with the various components of the wearable electronic device. The one or more processors 112 can be configured to process and execute executable software code to perform the various functions of the wearable electronic device. A storage device, such as memory 113, can optionally store the executable software code 116 used by the one or more processors 112 during operation.

The wearable electronic device also includes a wireless communication device 114. The wireless communication device 114 can be configured for wired or wireless communication with one or more other devices or networks. The networks can include a wide area network, a local area network, and/or personal area network. The wireless communication device 114 may also utilize wireless technology for communication, such as, but are not limited to, peer-to-peer or ad hoc communications such as HomeRF, Bluetooth.sup.TM and IEEE 802.11 (a, b, g or n); and other forms of wireless communication such as infrared technology. The wireless communication device 114 can include wireless communication circuitry, one of a receiver, a transmitter, or transceiver, and one or more antennas 115.

In one or more embodiments, the wearable electronic device includes other components 125, one example of which is an audio capture device 117. The audio capture device 117 is operable to receive audio input from a source, such as a person, authorized user, plurality of persons within an environment about the wearable electronic device, from the environment about the wearable electronic device, or combinations thereof. The audio capture device 117 can include hardware, executable code, and speech monitor executable code in one embodiment. The audio capture device 117 can be operable with one or more predefined authentication references 121.

The predefined authentication references 121 can comprise representations of basic speech models, representations of trained speech models, or other representations of predefined audio sequences that are used by the audio capture device 117 to receive and identify speech captured by an audio capture device 117, one example of which are the one or more microphones 102 carried by the housing 104 of the electronic device 100. In one embodiment, the audio capture device 117 can include a voice interface engine. Regardless of the specific implementation utilized in the various embodiments, the audio capture device 117 can access various speech models stored with the predefined authentication references 121 to identify speech commands in one or more embodiments.

The audio capture device 117 can include a beam steering engine. The beam steering engine can be operable with one or both of an audio input device, such as one or more microphones 102, and/or an audio output device, such as one or more loudspeakers. When functioning with the audio capture device 117, the beam steering engine can process audio input from, for example, one or more microphones 102 defining a virtual microphone. This virtual microphone can define an acoustic reception cone that can be virtually “steered” around the wearable electronic device. Alternatively, actual steering can occur as well, such as switching between a left microphone and right microphone or a front and back microphone or switching various microphones ON and OFF individually. In one or more embodiments, two or more microphones can be included for selective beam steering by the beam steering engine.

Various sensors 119 can be operable with the one or more processors 112. A first example of a sensor that can be included with the various sensors 119 is a touch sensor. The touch sensor can include a capacitive touch sensor, an infrared touch sensor, resistive touch sensors, or another touch-sensitive technology. The touch sensor can be configured to detect an object in close proximity with – or touching – the surface of the display or the housing 104 of the wearable electronic device.

Another example of a sensor 119 is a geo-locator that serves as a location detector 120. In one embodiment, location detector 120 is able to determine location data. Location can be determined by capturing the location data from a constellation of one or more earth orbiting satellites, or from a network of terrestrial base stations to determine an approximate location. The location detector 120 may also be able to determine location by locating or triangulating terrestrial base stations of a traditional cellular network, such as a CDMA network or GSM network, or from other local area networks, such as Wi-Fi networks.

One or more motion detectors can be configured as an orientation detector that determines an orientation and/or movement of the wearable electronic device in three-dimensional space. Illustrating by example, the orientation detector can include an accelerometer, gyroscopes, or other device to detect device orientation and/or motion of the wearable electronic device. Using an accelerometer as an example, an accelerometer can be included to detect motion of the electronic device. Additionally, the accelerometer can be used to sense some of the gestures of the user, such as one talking with their hands, running, or walking.

The orientation detector can determine the spatial orientation of the wearable electronic device in three-dimensional space by, for example, detecting a gravitational direction. In addition to, or instead of, an accelerometer, an electronic compass can be included to detect the spatial orientation of the electronic device relative to the earth’s magnetic field. Similarly, one or more gyroscopes can be included to detect rotational orientation of the wearable electronic device.

Other components 125 operable with the one or more processors 112 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as the one or more loudspeakers, ultrasound transducers, or other alarms and/or buzzers. The other components 125 can also include a mechanical output component such as vibrating or motion-based mechanisms.

The other components 125 can optionally include a barometer operable to sense changes in air pressure due to elevation changes or differing pressures of the wearable electronic device. The other components 125 can also optionally include a light sensor that detects changes in optical intensity, color, light, or shadow in the environment of the wearable electronic device. An infrared sensor can be used in conjunction with, or in place of, the light sensor. Similarly, a temperature sensor can be configured to monitor temperature about an electronic device.

In one or more embodiments, the one or more processors 112 can define one or more process engines. One example of such a process engine is the companion device detector 111. The process engines can be a component of the one or more processors 112, operable with the one or more processors 112, defined by the one or more processors 112, and/or integrated into the one or more processors 112. Other configurations for the process engines, including as software or firmware modules operable on the one or more processors 112, will be obvious to those of ordinary skill in the art having the benefit of this disclosure.

The companion device detector 111 can be operable with the various sensors to detect, infer, capture, and otherwise determine persons and actions that are occurring in the environment about the wearable electronic device. For example, where included one embodiment of the companion device detector 111 determines assessed contexts and frameworks using adjustable algorithms of context assessment employing information, data, and events. These assessments may be learned through repetitive data analysis and may be assisted by an artificial intelligence (AI) model 103.

Alternatively, a user may employ the user interface (where included) of the wearable electronic device to enter various parameters, constructs, rules, and/or paradigms that instruct or otherwise guide the companion device detector 111 in detecting contextual information to identify restricted area characteristics depicted in image sensor data captured by the image capture device 101. As noted, the companion device detector 111 can comprise an artificial neural network, an AI model 103, or other similar technology in one or more embodiments.

In one or more embodiments, the companion device detector 111 is operable with the one or more processors 112. In some embodiments, the one or more processors 112 can control the companion device detector 111. In other embodiments, the companion device detector 111 can operate independently, delivering information gleaned from detecting multi-modal social cues, emotional states, moods, and other contextual information to the one or more processors 112. The companion device detector 111 can receive data from the various sensors 119. In one or more embodiments, the one or more processors 112 are configured to perform the operations of the companion device detector 111.

In one or more embodiments, the companion device detector 111 is configured to analyze image sensor data 110 using the artificial intelligence model 103 trained to detect, based on predetermined image features and/or device appearance characteristics depicted in the image sensor data, a companion electronic device having a hardware camera and in a locked state. In one or more embodiments, the one or more sensors 119 are configured to determine a proximity between the image capture device 101 and the companion electronic device. In one or more embodiments, the one or more processors 112 are configured to cause the communication device 114 to transmit an unlock command 109 to the companion electronic device in response to detecting that the companion electronic device is locked and is within a predefined distance of the image capture device 101. As noted above, the one or more processors 112 can also cause the communication device 114 to automatically transmit, via the wireless communication channel, a lock command to the companion electronic device in response to detecting that the companion electronic device has moved beyond the predefined distance.

In some embodiments the other sensors 119 are included to offer supplementary environmental data, such as motion or proximity information. In one or more embodiments, these sensors contribute to the overall comprehension of the surrounding environment, thus enhancing the context awareness of the electronic device 100.

The one or more sensors 119 can support different input styles from the user 108. Illustrating by example, in one or more embodiments the electronic device 100 supports both gesture-based and non-gesture-based input styles.

The gesture-based input style refers to receiving user inputs that are gestures. These gestures may be applied to a touch-sensitive device, such as a touchscreen or a trackpad (where included). In some implementations, gestures performed within the field of view of the image capture device 101 may be detected and used to control the functionality of the electronic device 100. Gestures can include swipes, touch-and-hold actions, multi-finger swipes or movements, finger or hand movement patterns, combinations thereof, and so forth. The non-gesture-based input style refers to receiving user inputs that are not gestures, such as engagement of one or more buttons (e.g., mouse clicks on a virtual button, pressing a physical button), keyboard keys, and so forth.

The electronic device 100 of FIG. 1 is equipped with a companion electronic device detection system, which can be implemented in a variety of different manners. For example, the companion electronic device detection system can be realized as multiple instructions stored on computer-readable storage media and executed by the processors 112. Additionally, or alternatively, the companion electronic device detection system can be implemented at least in part in hardware, such as an application-specific integrated circuit (ASIC), a field-programmable gate array (FPGA), an application-specific standard product (ASSP), a system-on-a-chip (SoC), a complex programmable logic device (CPLD), and so forth. This system is designed to identify locked companion electronic devices operating within an environment of the electronic device and seamlessly transmit unlock commands 109 thereafter.

To achieve this, in some embodiments the companion electronic device detection system employs at least one machine-learning model trained to recognize companion electronic device characteristics in image data. For example, a machine-learning model may process preview image frames generated by the electronic device 100 substantially in real-time (e.g., as the preview image frames are generated) to determine whether the frames depict a recognized companion electronic device.

As one example of processing preview image frames substantially in real-time, the companion electronic device detection system may acquire a first preview image frame and a second preview image frame sequentially using the image capture device 101. The first and second preview image frames may be acquired at a rate of thirty frames per second, as one non-limiting example (e.g., with approximately 0.03 seconds elapsing between acquisition of the first and second frames). One or more machine-learning models are operable to process the first preview image frame before the second frame is acquired (e.g., within the approximately 0.03-second duration between acquiring the frames). In some implementations, the rate of acquiring the preview image frames may be higher (e.g., sixty frames per second), and the machine-learning models are operable to process each frame before acquiring the next, even at such high rates.

To support such high speeds of processing, the machine-learning models can be trained specifically to detect companion electronic device characteristics while ignoring other features depicted by the frames. For example, the models may be trained using images depicting companion electronic devices without being trained on other types of images depicting unrelated subject matter (e.g., human faces).

As a result, the processing speed of the models can be much faster (e.g., twice as fast) compared to models trained to recognize other types of media. Additionally, the resulting size of the models may be much smaller (e.g., half the size) compared to models trained on other media types.

While some systems employ remote machine-learning models accessible via a network (e.g., cloud-based models) for operations such as facial recognition, the reduced size of the models implementing the described techniques enables them to be stored locally within a memory of the electronic device 100. The local storage of the models can further increase the processing speed of the preview image frames to support the substantially real-time processing described above. However, the storage location of the models is non-limiting, and in some implementations, the models may be accessible over a network (e.g., via wired or wireless electronic communications between the electronic device 100 and remote systems implementing the models using cloud-based storage).

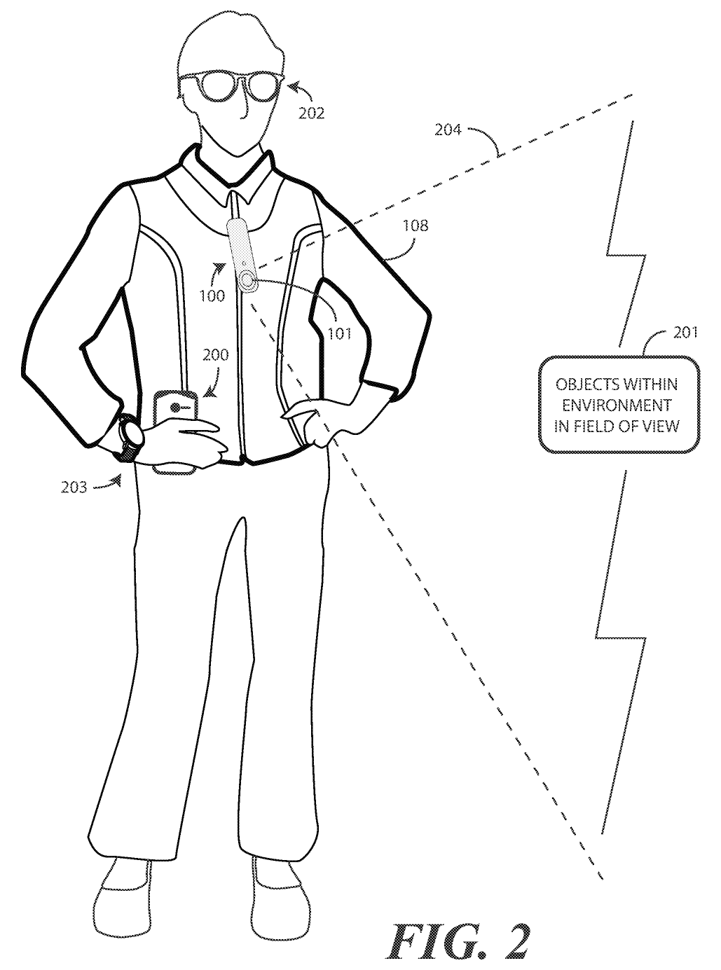

Embodiments of the disclosure contemplate that the electronic device 100 of FIG. 1 can operate in tandem with one or more companion electronic devices. Turning now to FIG. 2, illustrated therein is one explanatory system where the electronic device 100 is in operation with multiple companion electronic devices to monitor objects within a field of view of the image capture device 101.

FIG. 2 illustrates one explanatory system in which various mobile devices that in communication with each other. The system of FIG. 2 is operable to implement the described techniques for companion electronic device detection. In particular, a smartphone 200, a smart watch 203, the electronic device 100 of FIG. 1, and smart glasses 202 are shown.

The various devices can be worn or otherwise fixed to a body of a user 108 in some instances. For example, the smart watch 203 is depicted fixed to a wrist of the user 108, the smart glasses 202 are depicted supported at a face of the user 108, and the electronic device 100 of FIG. 1 is depicted supported at a chest of the user 108 by a lanyard defined by the first strap (105) and second strap (106). Some devices, such as the smartphone 200, can be adjusted from being worn by the user 108 (e.g., stowed to a holster) to being held by the user, or vice versa.

The devices depicted by FIG. 2 are non-limiting example devices that can implement the companion electronic device detection system. The depicted devices can include components that are similar to, or the same as, the components of the electronic device 100. For instance, the smartphone 200 can include the components such as the display, microphone, speaker, and so forth, that may be included in the electronic device 100. Moreover, each of the depicted devices can include an image sensor, such as the image capture device 101 of electronic device 100, which can be employed for acquiring the image sensor data 204 depicting objects within the environment 201 of the system. In one or more embodiments, this image sensor data 204 can then be processed by the companion device detector (111) for generating the preview image data that can be analyzed using the artificial intelligence model (103) to generate companion electronic device identifications from the image sensor data 204.

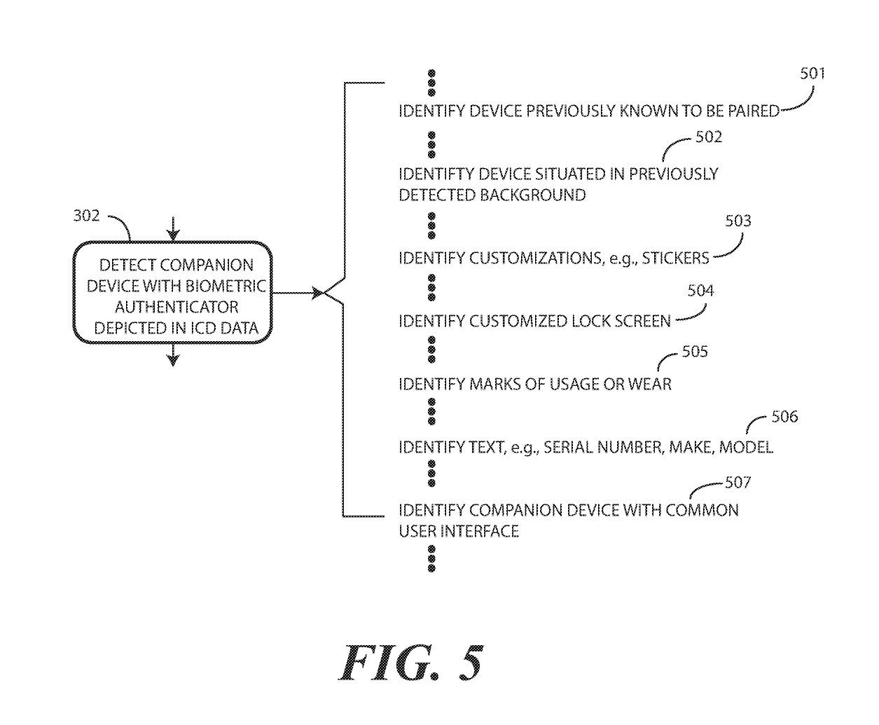

Companion electronic device identifications can be generated when the artificial intelligence model (103) finds items indicating that an environment includes a locked companion electronic device. FIG. 5 illustrates some examples of such items. Others will be obvious to those of ordinary skill in the art having the benefit of this disclosure.

In one or more embodiments, the identification of a companion electronic device is achieved through the analysis of specific characteristics that distinguish the device from other electronic devices. These characteristics may include the presence of a hardware camera configured for optical biometric authentication, which is a significant feature of companion devices.

Additionally, the companion device may exhibit distinctive appearance traits, such as a user-customized lock screen or notable physical attributes like color, shape, or the presence of specific decals or stickers that are not typically found on non-companion devices. The companion device may also be recognized by the operational state, such as being in a locked mode, which is a prerequisite for initiating the unlocking process.

Furthermore, the device's proximity to the wearable electronic device, determined through sensors or wireless communication protocols like Bluetooth or ultra-wideband, serves as an additional distinguishing factor, ensuring that only devices within a predefined range are identified as companions. These characteristics, when analyzed collectively, enable the system to accurately differentiate companion electronic devices from other electronic devices in the environment

In some embodiments, the system of FIG. 2 includes smart glasses 202 as a companion electronic device that actively communicates with the communication device of electronic device 100, enabling the one or more processors of electronic device 100 to execute companion electronic device unlocking operations in response to receiving electronic communications from the smart glasses 202. This configuration is beneficial as it allows for enhanced situational awareness by leveraging the additional sensory inputs and processing capabilities of the smart glasses 202.

For instance, in scenarios where the image capture device 101 of electronic device 100 may have limited visibility or is obstructed, the smart glasses can provide supplementary data to ensure accurate detection of locked companion electronic devices. Use cases where this approach is preferable include environments with complex layouts, such cubicles or shared office spaces, where the smart glasses can detect particular stickers attached to a companion electronic device that may not be visible to the wearable device alone.

Additionally, in dynamic settings like airports or security checkpoints, the smart glasses can quickly relay information about companion electronic devices to the electronic device 100, allowing for timely execution of unlocking operations without relying solely on the image capture device 101. This collaborative functionality between the smart glasses and electronic device 100 enhances the overall effectiveness of the system in performing seamless unlocking operations. Thus, in one or more embodiments the one or more processors of electronic device 100 are further configured to, in response to the communication device receiving an electronic communication from a companion electronic device indicating a locked companion electronic device is within the environment, to transmit an unlock command to the companion electronic device.

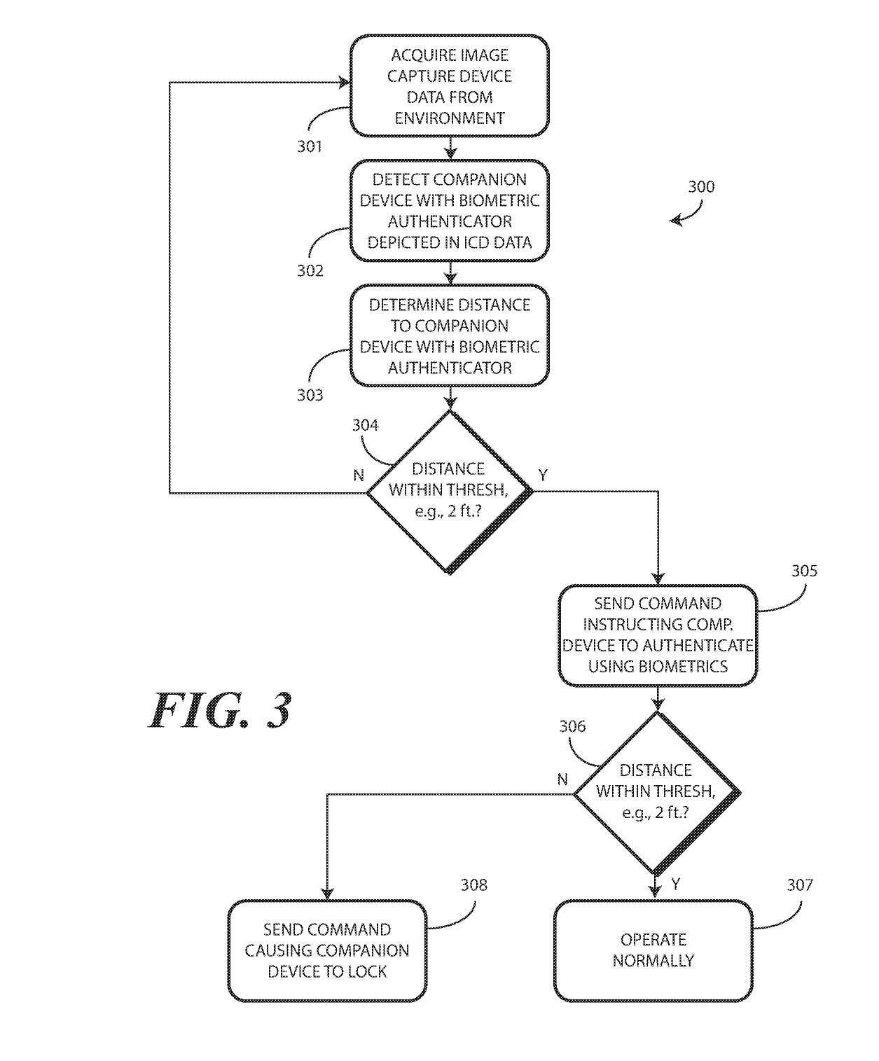

Turning now to FIG. 3, illustrated therein is one explanatory method 300 in accordance with one or more embodiments of the disclosure. Beginning at step 301, in one or more embodiments an image capture device captures image capture device from an environment of the electronic device. In one or more embodiments, step 301 comprises one or more processors of the electronic device carrying the image capture device receiving the image sensor data from the image capture device.

In one or more embodiments, step 302 comprises the one or more processors analyzing the image sensor data to identify a recognized companion electronic device being depicted in the image sensor data. In one or more embodiments, step 302 comprises employs an artificial intelligence image classification algorithm to detect the companion electronic device using predetermined image features and device appearance characteristics as inputs.

In one or more embodiments, the image sensor data captured by the electronic device may depict various companion electronic device characteristics that identify the companion electronic device as a known companion electronic device. Turning briefly to FIG. 5, illustrated therein are some examples. Others will be obvious to those of ordinary skill in the art having the benefit of this disclosure.

In step 302 of FIG. 5, one characteristic of a companion electronic device that can be detected is the identification of a device 501 that has been previously paired with the electronic device. This identification process leverages historical pairing data stored within the electronic device, allowing the electronic device to recognize and authenticate devices that have established a prior connection.

For instance, in a professional setting, a user may have a laptop that is frequently paired with a wearable camera device for seamless unlocking during meetings. The electronic device can quickly identify the laptop as a previously paired device, facilitating an automatic unlock without manual intervention. Similarly, in a home environment, a smart TV that has been paired with the electronic device for media streaming can be recognized, enabling the user to access entertainment applications effortlessly.

In public spaces, such as cafes or airports, the electronic device can identify a previously paired smartphone, allowing the user to securely unlock the phone without needing to input credentials manually. These use cases demonstrate the practicality and convenience of identifying previously paired devices, enhancing user experience by streamlining device interactions across various environments.

In step 302 of FIG. 5, another characteristic of a companion electronic device that can be detected includes the identification of a device situated in a previously detected background scene 502. This capability leverages the electronic device's ability to recognize and recall specific environmental contexts in which the companion device was previously identified.

For instance, in a professional setting, a user may frequently use a laptop in a conference room with a distinctive background, such as a particular wall art or furniture arrangement. The electronic device can recognize this background scene and automatically identify the laptop as a companion device, facilitating seamless unlocking during meetings.

Similarly, in a home environment, a smart TV located in a living room with distinct decor, such as a specific painting or bookshelf, can be identified based on the background scene, allowing the user to access entertainment applications effortlessly. In public spaces, such as cafes or airports, the electronic device can recognize a previously detected background scene, like a specific seating area or architectural feature, to identify a companion smartphone, ensuring secure and convenient unlocking without manual input. These use cases demonstrate the practicality and convenience of identifying devices based on previously detected background scenes, enhancing user experience by streamlining device interactions across various environments.

In step 302 of FIG. 5, another characteristic of a companion electronic device that can be detected includes the identification of device customizations 503, such as stickers. These customizations serve as identifiers that distinguish the companion device from other electronic devices within the environment.

For instance, in a professional setting, a user may have a laptop adorned with company logos or specific project-related stickers, allowing the electronic device to recognize and authenticate the laptop as a companion device, thereby facilitating seamless unlocking during meetings or collaborative sessions. Similarly, in a home environment, a tablet personalized with family photos or decorative stickers can be identified based on these customizations, enabling the user to access entertainment or educational applications effortlessly. In public spaces, such as cafes or libraries, the electronic device can identify a smartphone with distinct decals or stickers, ensuring secure and convenient unlocking without manual input. These use cases demonstrate the practicality and convenience of identifying devices based on customizations, enhancing user experience by streamlining device interactions across various environments.

In step 302 of FIG. 5, another characteristic of a companion electronic device that can be detected includes the identification of a customized lock screen 504. This feature leverages the electronic device's ability to recognize specific visual elements displayed on the lock screen of the companion device, which serve as identifiers distinguishing the companion device from other devices.

For instance, in a professional setting, a user may have a laptop with a lock screen displaying a company logo or a project-specific image, allowing the electronic device to recognize and authenticate the laptop as a companion device, thereby facilitating seamless unlocking during meetings or collaborative sessions. Similarly, in a home environment, a tablet with a lock screen featuring family photos or personalized artwork can be identified based on these customizations, enabling the user to access entertainment or educational applications effortlessly. In public spaces, such as cafes or libraries, the electronic device can identify a smartphone with a lock screen displaying distinct themes or wallpapers, ensuring secure and convenient unlocking without manual input. These use cases demonstrate the practicality and convenience of identifying devices based on customized lock screens, enhancing user experience by streamlining device interactions across various environments.

In step 302 of FIG. 5, another characteristic of a companion electronic device that can be detected includes the identification of marks of usage 505 or wear. This feature leverages the electronic device's ability to recognize specific signs of wear and tear that are specific to the companion device, distinguishing the companion device from other devices within the environment.

For instance, in a professional setting, a user may have a laptop with a worn-out keyboard or a scratched surface, which the electronic device can identify as a companion device, facilitating seamless unlocking during meetings or collaborative sessions. Similarly, in a home environment, a tablet with a scuffed case or a smartphone with a cracked screen can be recognized based on these usage marks, enabling the user to access entertainment or communication applications effortlessly. In public spaces, such as cafes or libraries, the electronic device can identify a smartphone with distinctive wear patterns, ensuring secure and convenient unlocking without manual input. These use cases demonstrate the practicality and convenience of identifying devices based on marks of usage, enhancing user experience by streamlining device interactions across various environments.

In step 302 of FIG. 5, another characteristic of a companion electronic device that can be detected includes the identification of serial numbers, makes, or models 506. This feature leverages the electronic device's ability to recognize specific identifying information that distinguishes the companion device from other electronic devices within the environment.

For instance, in a professional setting, a user may have a laptop with a distinct serial number or a specific model that the electronic device can identify, facilitating seamless unlocking during meetings or collaborative sessions. Similarly, in a home environment, a smart TV with a particular make or model can be recognized based on these identifiers, enabling the user to access entertainment applications effortlessly. In public spaces, such as cafes or libraries, the electronic device can identify a smartphone with a specific serial number or model, ensuring secure and convenient unlocking without manual input. These use cases demonstrate the practicality and convenience of identifying devices based on serial numbers, makes, or models, enhancing user experience by streamlining device interactions across various environments.

In step 302 of FIG. 5, another characteristic of a companion electronic device that can be detected includes the identification of a common user interface 507, such as when a music player is active on the electronic device and the controls for the music player appear on the companion electronic device. This feature leverages the electronic device's ability to recognize specific visual elements associated with the user interface of applications running on the companion device, which serve as identifiers distinguishing the companion device from other devices.

For instance, in a professional setting, a user may have a laptop with a music player application running, and the electronic device can recognize the music player controls displayed on a connected smartphone, facilitating seamless interaction and control of the music playback without manual intervention. Similarly, in a home environment, a smart TV displaying a streaming service interface can be identified based on the appearance of playback controls on a tablet, enabling the user to manage media content effortlessly. In public spaces, such as cafes or libraries, the electronic device can identify a smartphone with a music player interface, ensuring secure and convenient control of audio playback without manual input. These use cases demonstrate the practicality and convenience of identifying devices based on common user interfaces, enhancing user experience by streamlining device interactions across various environments.

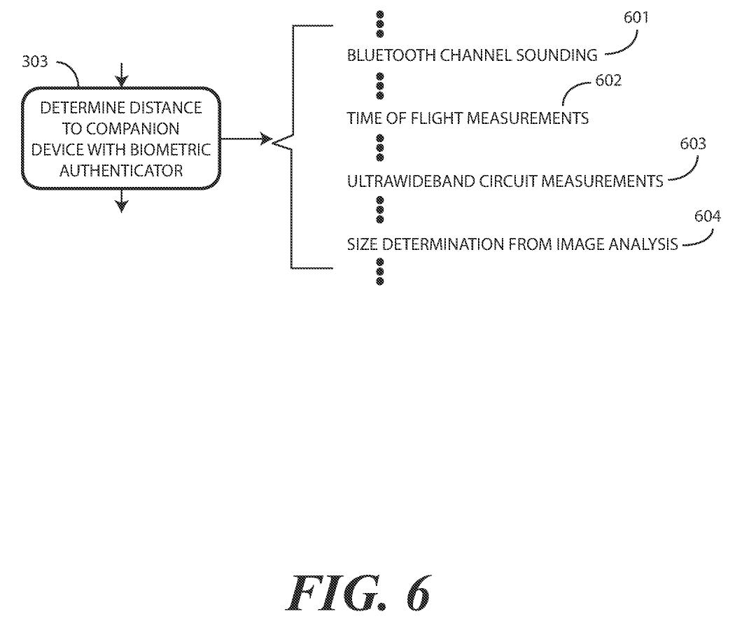

Turning now back to FIG. 3, at optional step 303, one or more processors of the electronic device determine, one or more sensors, a proximity between the electronic device and the companion electronic device by analyzing a distance indicative signal. This can be done in a variety of ways. Turning briefly to FIG. 6, illustrated therein are a few examples. Others will be obvious to those of ordinary skill in the art having the benefit of this disclosure.

At step 303 of FIG. 6, the one or more processors can determine the proximity between the electronic device and the companion electronic device using Bluetooth channel sounding 601. Bluetooth channel sounding is a technique that involves the transmission and reception of Bluetooth signals to estimate the distance between devices.

In one or more embodiments, this process begins with the electronic device sending a series of Bluetooth signals to the companion electronic device. The companion device then responds by sending signals back to the electronic device. The time taken for the signals to travel to the companion device and back is measured, allowing the processors to calculate the distance based on the speed of the Bluetooth signals.

This method leverages the known speed of radio waves and the time-of-flight principle to provide an accurate estimation of the distance between the devices. By continuously monitoring these signals, the electronic device can dynamically assess the proximity to the companion device, ensuring that the unlock command is only transmitted when the devices are within a predefined range, thereby enhancing security and user convenience.

At step 303 of FIG. 6, the one or more processors can determine the proximity between the electronic device and the companion electronic device using a time of flight measurement 602. This technique involves emitting a laser or infrared pulse from the electronic device towards the companion electronic device. The pulse travels to the companion device and reflects back to the electronic device. The time taken for the pulse to travel to the companion device and return is measured by the processors. By knowing the speed of light, the processors can calculate the distance between the devices based on the time of flight of the pulse. This method provides an accurate and reliable measurement of proximity, ensuring that the unlock command is only transmitted when the devices are within a predefined range, thereby enhancing security and user convenience.

At step 303 of FIG. 6, the one or more processors can determine the proximity between the electronic device and the companion electronic device using ultra-wide band (UWB) signals 603. This technique involves the transmission of UWB signals, which are characterized by their broad frequency spectrum and short pulse duration, allowing for precise distance measurement.

The electronic device emits UWB pulses towards the companion electronic device, which then reflects these pulses back to the electronic device. By measuring the time required for the pulses to travel to the companion device and return, the processors can calculate the distance between the devices based on the known speed of the UWB signals. This method provides high accuracy and reliability in proximity detection, ensuring that the unlock command is transmitted only when the devices are within a predefined range, thereby enhancing security and user convenience.

At step 303 of FIG. 6, the one or more processors can determine the proximity between the electronic device and the companion electronic device using image analysis 604 by evaluating the size of the companion electronic device depicted in the image sensor data. This technique involves capturing an image of the environment with the image capture device and analyzing the dimensions of the companion electronic device within the image.

By comparing the observed size of the companion device in the image to known size parameters stored in the electronic device's memory, the processors can infer the distance between the electronic device and the companion device. The principle underlying this method is that the apparent size of an object in an image decreases as the distance from the camera increases. By accurately measuring the size of the companion device in the image and referencing the known dimensions, the processors can calculate the distance with precision, ensuring that the unlock command is transmitted only when the devices are within a predefined range, which enhances security and user convenience.

Turning now back to FIG. 3, in one or more embodiments decision 304 determines whether the proximity of the companion electronic device is within a predetermined proximity, one example of which is two feet or less. In one or more embodiments, the automatically transmitting the unlock command occurs only when the companion electronic device is within a predetermined proximity of the electronic device.

Step 305 comprises, responsive to detecting the companion electronic device within the environment of the electronic device, automatically transmitting, by a communication device, an unlock command to the companion electronic device causing the companion electronic device to initiate the biometric authentication of the user. In one or more embodiments, step 305 only occurs when the companion electronic device is locked. In one or more embodiments, step 305 only occurs when the companion electronic device is within a predetermined proximity of the electronic device.

Upon determining that the companion electronic device is within the predetermined proximity, the electronic device initiates the sequence of steps to automatically transmit the unlock command. Initially, the one or more processors of the electronic device analyze the image sensor data to confirm the presence of the companion electronic device, ensuring the companion electronic device is configured for optical biometric authentication and is in a locked state. Once confirmed, the processors utilize the communication device to establish a wireless communication channel with the companion electronic device.

Subsequently, the processors generate an unlock command, which is then transmitted via the established communication channel to the companion electronic device. This unlock command prompts the companion electronic device to initiate the biometric authentication process, thereby facilitating the unlocking of the device without requiring explicit user interaction. This sequence ensures a seamless and efficient unlocking process, enhancing user convenience and maintaining security by leveraging proximity-based detection and wireless communication technologies.

Decision 306 continues to monitor the proximity between the electronic device and the companion electronic device. In response to the proximity exceeding another predetermined proximity, the method 300 moves to step 308, which comprises automatically transmitting a lock command to the companion electronic device causing the companion electronic device to enter a locked state. Otherwise, the companion electronic device operates normally at step 307.

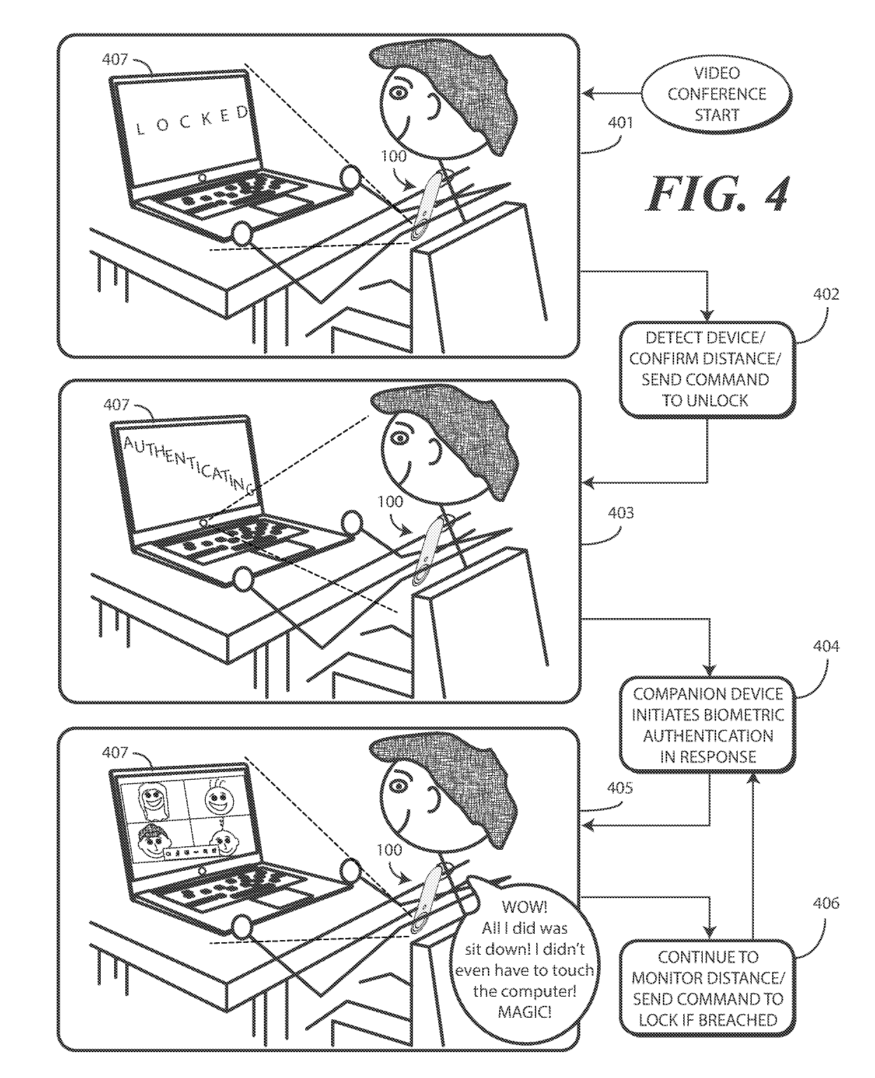

To see the method 300 of FIG. 3 in action, turn now to FIG. 4 where one or more method steps are shown. Turning now to FIG. 4, illustrated therein are one or more method steps involving Buster, who is depicted as eagerly preparing to join a videoconference to discuss the art of comping for a singer using the rhythm pioneered by pianist Red Garland. In this embodiment, the illustrated narrative conveys that the rhythm in question involves anticipating chords on the "and" of two and the "and" of four, a technique that Buster is particularly keen to perfect.

At step 401, Buster is depicted as wearing an electronic device 100, which he proudly showcases to his fellow musicians, specifically highlighting the sleek design and advanced capabilities of the device. Concurrently, a companion electronic device 407, depicted as a laptop computer, is shown in a locked state.

At step 402, the electronic device 100, which is equipped with one or more processors, is configured to monitor image sensor data received from the camera. Simultaneously, one or more sensors are operable to determine the proximity between the camera and the electronic device 100. In this embodiment, the processors further employ an AI image classification algorithm to detect, based on predetermined image features and device appearance characteristics, the presence of the companion electronic device 407, which is further characterized by the incorporation of a hardware camera and a locked state. In this context, Buster remains focused on the upcoming discussion regarding rhythm and timing, albeit unaware of the underlying technical operations.

As illustrated at step 403, the electronic device 100 automatically transmits an unlock command via a wireless communication channel to the companion electronic device 407. This operation is triggered upon the detection of the companion device being in a locked state and the proximity of the companion device falling within a predefined distance of the camera. As a result, Buster is depicted as mentally rehearsing his chord progressions, eagerly anticipating the opportunity to impress his peers with his burgeoning rhythmic prowess.

Subsequently, at step 404, the companion electronic device 407 is configured to perform biometric authentication, a process that Buster finds to be entirely magical. Thereafter, as depicted at step 405, the result of this operation is rendered wherein the laptop unlocks without requiring any tactile engagement from Buster. In this context, Buster is left visibly in awe as he exclaims, "Wow! All I did was sit down! I didn't even have to touch the computer! Magic!" Thus, the seamless unlocking operation engenders a feeling in Buster that he is operating as a tech-savvy wizard, ready to engage in the musical conversation with augmented confidence.

As the method advances to step 406, the electronic device 100 continues to monitor the distance between itself and the companion electronic device 407. In embodiments wherein a predefined distance is exceeded, a lock command is automatically transmitted via the wireless communication channel, thereby ensuring the security of the companion device. Under these circumstances, while Buster remains fully engaged in the videoconference and captivated by the discussion on Red Garland's rhythmic techniques, he remains unaware of the ongoing monitoring operations that safeguard the companion electronic device.

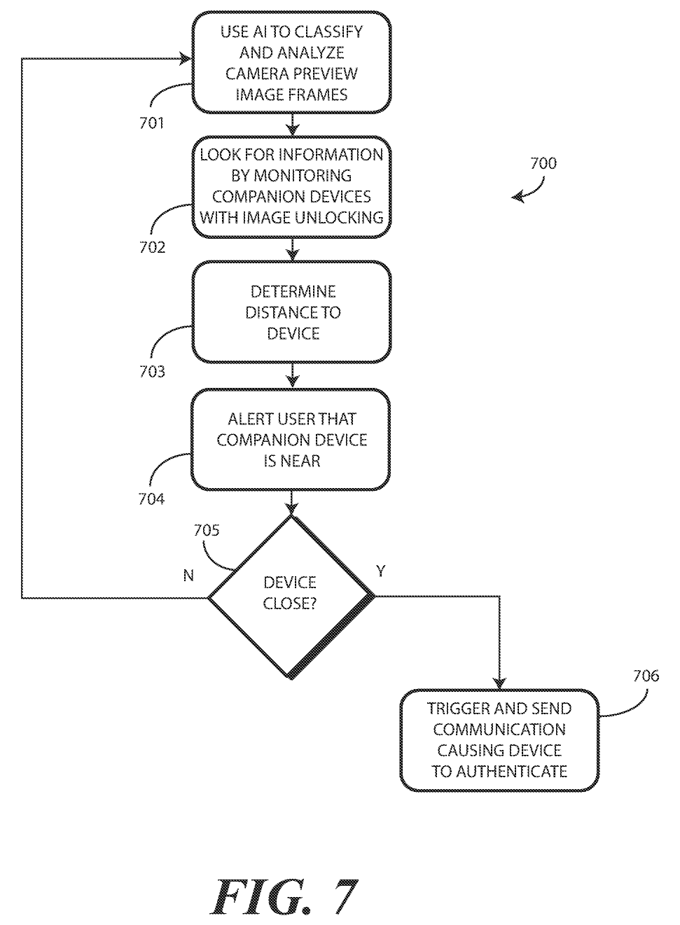

Turning now to FIG. 7, illustrated therein is another explanatory method 700 in accordance with one or more embodiments of the disclosure. In one or more embodiments, step 701 in FIG. 7 involves employing artificial intelligence (AI) to classify and analyze camera preview image frames.

Under ordinary conditions, this step plays a role in the system’s ability to identify companion devices equipped with biometric authentication capabilities. Accordingly, the AI model—integrated into the electronic device—processes the image frames captured by the image capture device to detect specific features and characteristics indicative of a companion device.

In some embodiments, the AI model is trained to recognize various attributes, such as device appearance, user customizations, and operational states, which are important for distinguishing companion devices from other electronic devices within the environment. As a result, the AI’s ability to perform real-time analysis ensures that the system can promptly identify companion devices, thereby facilitating seamless device collaboration and unlocking processes.

In one or more embodiments, step 702 is directed towards monitoring companion devices with image unlocking capabilities to seek out pertinent information. In this context, the step builds upon the AI’s prior classification and analysis, as the electronic device continuously scans its surroundings. Under ordinary conditions, the AI model is leveraged to identify devices that possess the necessary hardware—such as cameras—for optical biometric authentication. Thus, by focusing on devices with image unlocking capabilities, the monitoring process plays a significant role in ensuring that the system can detect companion devices in dynamic environments, thereby enhancing the accuracy and efficiency in initiating the unlocking process.

Thereafter, step 703 involves determining the distance to the companion device, a measure necessary for ensuring that the unlocking process is secure and appropriately initiated when the companion device is within a predefined proximity. In one or more embodiments, the electronic device employs various sensors and techniques—such as Bluetooth channel sounding, time-of-flight measurements, and ultra-wideband signals—to accurately measure the distance between the electronic device and the companion device. Under ordinary conditions, this distance determination is important for preventing unauthorized access, ensuring that the unlock command is transmitted only when the devices are sufficiently close, thereby enhancing both security and user convenience.

In one or more embodiments, step 704 involves alerting the user that the companion device is nearby. Indeed, in one or more embodiments step 704 comprises, responsive to detecting the companion electronic device within the environment of the electronic device, causing, by the one or more processors, a user interface of the electronic device to deliver an alert identifying that the companion electronic device is within the environment of the electronic device.

Accordingly, this step 704 serves as a notification mechanism, informing the user that a recognized companion device is within the necessary proximity for unlocking. In some embodiments, the alert can be delivered via various techniques, such as vibration, sound, or visual notification on the electronic device’s display. As a result, this user alert is important for maintaining transparency and ensuring that the user is apprised of the system’s operations, particularly in environments where multiple devices are present.

In one or more embodiments, decision 705 assesses whether the companion device is positioned sufficiently close to proceed with the unlocking process. Under ordinary conditions, this decision point evaluates the proximity data obtained in step 703 to determine whether the companion device is within the predefined distance threshold—such as two feet or less. In some embodiments, if the device is deemed close enough, the system proceeds to trigger the unlocking process; otherwise, the system continues to monitor the environment for changes in proximity. Accordingly, this decision-making process plays a significant role in maintaining security and ensuring that the unlocking process is initiated only under appropriate conditions.

In one or more embodiments, step 706 involves triggering and sending communication that causes the device to authenticate. Under ordinary conditions, once the proximity criteria are met, the electronic device sends an unlock command to the companion device, thereby prompting the companion device to initiate the biometric authentication process. Accordingly, this communication is facilitated through the electronic device’s communication device, which establishes a wireless channel with the companion device. In some embodiments, the unlock command is designed to activate the companion device’s biometric authentication capabilities, allowing the companion device to verify the user’s identity and unlock without manual intervention. As a result, this step plays a significant role in the system’s ability to provide a seamless and efficient unlocking experience, thereby enhancing user convenience and security

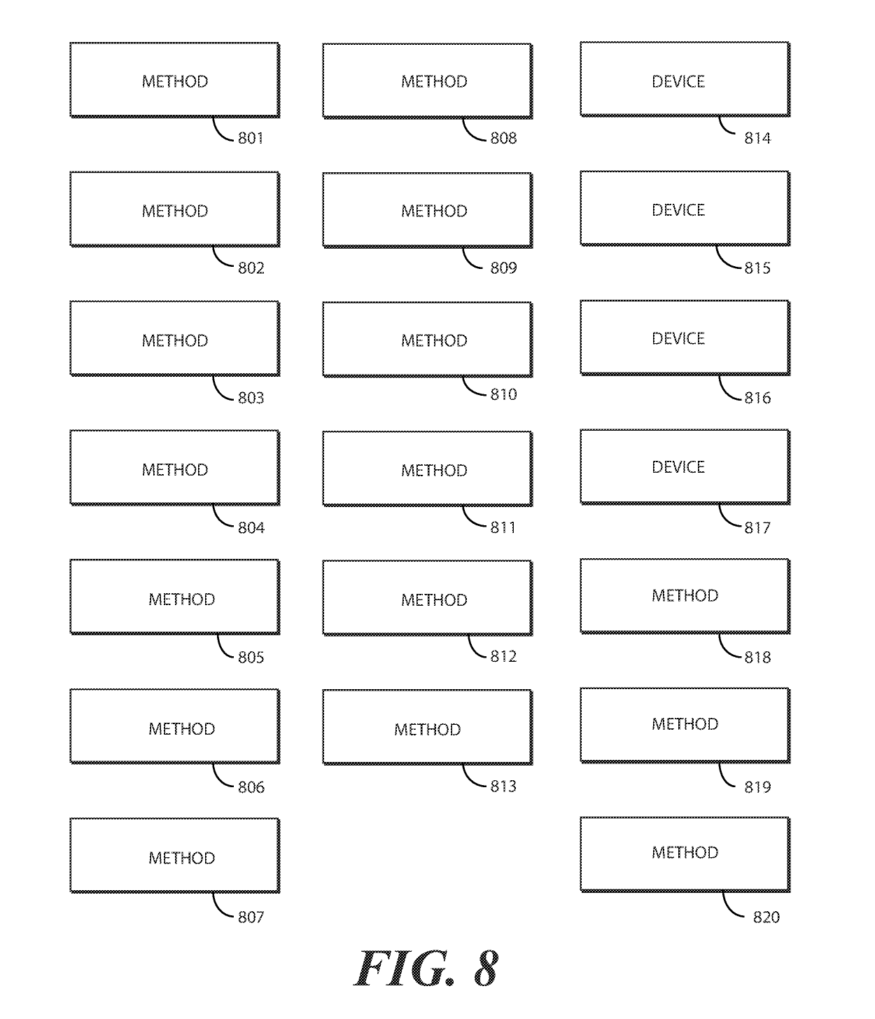

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in an electronic device comprises processing, by one or more processors, image sensor data received from an image capture device of the electronic device to detect a companion electronic device configured to perform optical biometric authentication of a user within an environment of the electronic device. At 801, the method comprises, responsive to detecting the companion electronic device within the environment of the electronic device, automatically transmitting, by a communication device, an unlock command to the companion electronic device causing the companion electronic device to initiate the biometric authentication of the user.

At 802, the processing of 801 employs an artificial intelligence image classification algorithm to detect the companion electronic device using predetermined image features and device appearance characteristics as inputs. At 803, the predetermined image features of 802 comprise user customizations applied to the companion electronic device. At 804, the device appearance characteristics of 802 comprise a user customized lock screen appearing on a display of the companion electronic device.

At 805, the automatic transmission of the unlock command of 801 occurs only when the companion electronic device is locked. At 806, the method of 805 further comprises determining, by the one or more processors using one or more sensors, a proximity between the electronic device and the companion electronic device by analyzing a distance indicative signal.

At 807, the automatic transmission of the unlock command of 806 occurs only when the companion electronic device is within a predetermined proximity of the electronic device. At 808, the predetermined proximity of 807 is two feet or less. At 809, the distance indicative signal of 807 is generated using a Bluetooth sounding process.

At 810, the distance indicative signal of 807 is generated using an ultra-wide band ranging process. At 811 the distance indicative signal of 807 is generated by determining a size of the companion electronic device in the image sensor data.

At 812, the method of 806 further comprises, after the automatically transmitting the unlock command, continuing to monitor the proximity between the electronic device and the companion electronic device. At 812, in response to the proximity exceeding another predetermined proximity, the method comprises automatically transmitting a lock command to the companion electronic device causing the companion electronic device to enter a locked state.

At 813, the electronic device of 812 is a wearable electronic device. At 814, the method of 801 further comprises, responsive to detecting the companion electronic device within the environment of the electronic device, causing, by the one or more processors, a user interface of the electronic device to deliver an alert identifying that the companion electronic device is within the environment of the electronic device.

At 815, an electronic device comprises an image capture device configured to capture image sensor data from an environment of the electronic device. At 815, the electronic device comprises a communication device and one or more processors operatively coupled to the image capture device and the communication device.

At 815, the one or more processors analyze the image sensor data to detect a companion electronic device configured to perform facial recognition to unlock the companion electronic device depicted in the image sensor data and automatically cause the communication device to transmit an unlock command to the companion electronic device depicted in the image sensor data. At 816, the one or more processors of 815 use an artificial intelligence image classification algorithm to identify the companion electronic device.

At 817, the electronic device of 815 further comprises one or more sensors. At 817, the one or more processors cause the one or more sensors to determine a distance between the electronic device and the companion electronic device. At 817, the one or more processors cause the communication device to transmit the unlock command when the distance is within a predefined proximity and the companion electronic device is in a locked state. At 818, when the one or more sensors of 817 determine the distance exceeds the predefined proximity after the unlock command is transmitted, the one or more processors cause the communication device to transmit a lock command to the companion electronic device.

At 819 a method in an electronic device comprises monitoring, by one or more processors, image sensor data received from a camera of the electronic device. At 819, the method comprises processing, by the one or more processors, the image sensor data with an AI image classification algorithm to detect, based on predetermined image features and/or device appearance characteristics depicted in the image sensor data, a companion electronic device having a hardware camera and in a locked state.

At 819, the method comprises determining, using one or more sensors, a proximity between the camera and the companion electronic device. At 819, the method comprises automatically transmitting, by a communication device via a wireless communication channel, an unlock command to the companion electronic device in response to detecting that the companion electronic device is locked and is within a predefined distance of the camera. At 829, the method of 819 further comprises automatically transmitting, via the wireless communication channel, a lock command to the companion electronic device in response to detecting that the companion electronic device has moved beyond the predefined distance.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment the electronic device is a wearable camera integrated into a pendant, which captures image sensor data from the environment and communicates with a companion electronic device, such as a smartphone, to initiate facial recognition for unlocking. The pendant may utilize a Bluetooth communication device to transmit unlock commands, ensuring seamless connectivity with the smartphone.

In another embodiment, the electronic device is a pair of augmented reality glasses equipped with an image capture device and communication capabilities. These glasses can detect a companion electronic device, such as a laptop, and automatically transmit unlock commands when the laptop is within a predefined proximity. The glasses may employ ultra-wideband technology for precise distance measurement between the devices.

In yet another embodiment, the electronic device is a smart camera mounted on a desktop, which monitors the environment and communicates with a companion electronic device, such as a tablet, to perform facial recognition. This smart camera may use AI image classification algorithms to identify the tablet based on its distinct appearance characteristics, such as color or case design, and initiate the unlocking process. Each embodiment demonstrates the adaptability of the system, allowing for various configurations and operational methods while maintaining the fundamental functionality of automatic device unlocking through image sensor data analysis and wireless communication

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
processing, by one or more processors, image sensor data received from an image capture device of the electronic device to detect a companion electronic device configured to perform optical biometric authentication of a user within an environment of the electronic device; and
responsive to detecting the companion electronic device within the environment of the electronic device, automatically transmitting, by a communication device, an unlock command to the companion electronic device causing the companion electronic device to initiate the optical biometric authentication of the user.

2. The method of claim 1, wherein the processing employs an artificial intelligence image classification algorithm to detect the companion electronic device using predetermined image features and device appearance characteristics as inputs.

3. The method of claim 2, wherein the predetermined image features comprise user customizations applied to the companion electronic device.

4. The method of claim 2, wherein the device appearance characteristics comprise a user customized lock screen appearing on a display of the companion electronic device.

5. The method of claim 1, wherein the automatically transmitting the unlock command occurs only when the companion electronic device is locked.

6. The method of claim 5, further comprising determining, by the one or more processors using one or more sensors, a proximity between the electronic device and the companion electronic device by analyzing a distance indicative signal.

7. The method of claim 6, wherein the automatically transmitting the unlock command occurs only when the companion electronic device is within a predetermined proximity of the electronic device.

8. The method of claim 7, wherein the predetermined proximity is two feet or less.

9. The method of claim 7, wherein the distance indicative signal is generated using a Bluetooth sounding process.

10. The method of claim 7, wherein the distance indicative signal is generated using an ultra-wide band ranging process.

11. The method of claim 7, wherein the distance indicative signal is generated by determining a size of the companion electronic device in the image sensor data.

12. The method of claim 6, further comprising, after the automatically transmitting the unlock command, continuing to monitor the proximity between the electronic device and the companion electronic device and, in response to the proximity exceeding another predetermined proximity, automatically transmitting a lock command to the companion electronic device causing the companion electronic device to enter a locked state.

13. The method of claim 12, wherein the electronic device is a wearable electronic device.

14. The method of claim 1, further comprising, responsive to detecting the companion electronic device within the environment of the electronic device, causing, by the one or more processors, a user interface of the electronic device to deliver an alert identifying that the companion electronic device is within the environment of the electronic device.

15. An electronic device, comprising:
an image capture device configured to capture image sensor data from an environment of the electronic device;
a communication device; and
one or more processors operatively coupled to the image capture device and the communication device;
wherein the one or more processors analyze the image sensor data to detect a companion electronic device configured to perform facial recognition to unlock the companion electronic device depicted in the image sensor data and automatically cause the communication device to transmit an unlock command to the companion electronic device depicted in the image sensor data.

16. The electronic device of claim 15, wherein the one or more processors use an artificial intelligence image classification algorithm to identify the companion electronic device.

17. The electronic device of claim 15, further comprising one or more sensors, wherein the one or more processors cause the one or more sensors to determine a distance between the electronic device and the companion electronic device and cause the communication device to transmit the unlock command when the distance is within a predefined proximity and the companion electronic device is in a locked state.

18. The electronic device of claim 17, wherein when the one or more sensors determine the distance exceeds the predefined proximity after the unlock command is transmitted the one or more processors cause the communication device to transmit a lock command to the companion electronic device.

19. A method in an electronic device, the method comprising:
monitoring, by one or more processors, image sensor data received from a camera of the electronic device;
processing, by the one or more processors, the image sensor data with an AI image classification algorithm to detect, based on predetermined image features and/or device appearance characteristics depicted in the image sensor data, a companion electronic device having a hardware camera and in a locked state;
determining, using one or more sensors, a proximity between the camera and the companion electronic device; and
automatically transmitting, by a communication device via a wireless communication channel, an unlock command to the companion electronic device in response to detecting that the companion electronic device is locked and is within a predefined distance of the camera.

20. The method of claim 19, further comprising automatically transmitting, via the wireless communication channel, a lock command to the companion electronic device in response to detecting that the companion electronic device has moved beyond the predefined distance.
